(19) United States
(12) Patent Application Publication
(10) Pub. No.: US 2012/0295651 A1
(43) Pub. Date: Nov. 22, 2012

(54) ADAPTIVE ARRAY BASE STATION AND COMMUNICATION METHOD FOR ADAPTIVE ARRAY BASE STATION

(75) Inventor: Nobuaki Takamatsu, Kanagawa (JP)

(73) Assignee: KYOCERA CORPORATION, Kyoto (JP)

(21) Appl. No.: 13/519,560

(22) PCT Filed: Dec. 24, 2010
(86) PCT No.: PCT/JP2010/007522

§ 371 Date: Jun. 27, 2012

(30) Foreign Application Priority Data
Dec. 28, 2009 (JP) 2009-298028

(51) Int. Cl. H04W 72/04

(52) U.S. Cl. 455/509

(57) ABSTRACT

To transmit at least a part of control information by adaptive array control, an adaptive array base station (1), which assigns to a mobile station a part of each of a control information region including control information and a user data region separated from the control information region in a time direction and including user data, includes a calculation unit (21) calculating a transmission weight based on a received signal from the mobile station, an assigning unit (50) assigning the control information for one mobile station to a control information region in the same frequency band as the user data region to which the user data for the mobile station is assigned, and a transmission unit (10) transmitting the control information and the user data to the mobile station by the adaptive array control based on the transmission weight and assignment of the control information and the user data.

### CROSS REFERENCE TO RELATED APPLICATION

This application claims priority to and the benefit of Japanese Patent Application No. 2009-298028 (filed on Dec. 28, 2009), the entire contents of which are incorporated herein by reference.

### TECHNICAL FIELD

The present invention relates to an adaptive array base station and a communication method for the adaptive array base station.

### BACKGROUND ART

A mobile communication system standardization project, 3GPP, has recently been deliberating about LTE (Long Term Evolution). According to the LIE, a base station assigns a resource block (RB) to a mobile station for a downlink communication from the base station to the mobile station.

According to the LTE, as illustrated in FIG. 4, a frequency band of a system is divided into a plurality of resource blocks (RBs), each of which includes one or more subcarriers (radio communication channels) (twelve subcarriers in FIG. 4). According to the LIE, basically, the resource blocks are assigned in subframes (communication frames) of 1 ms to the mobile stations.

According to the LTE, the subframe includes a control information region such as PDCCH (Physical Downlink Control Channel) for transmitting control information and a user data region such as PDSCH (Physical Downlink Shared Channel) for transmitting user data. The PDCCH is assigned to the first to the third symbols in the subframe. The PDSCH is separated from the PDCCH in terms of time and assigned to symbols subsequent to the symbols to which the PDCCH is assigned, that is, the fourth symbol and thereafter, for example. The mobile station is notified of the number of symbols used for the PDCCH by PCFICH (Physical Control Format Indicator Channel) (not illustrated) included in the first symbol to which the PDCCH is assigned (for example, see Non-Patent Document 1).

### RELATED ART DOCUMENT

### Non-Patent Document

Non-Patent Document 1: 3GPP TS36.211 (V8.7.0), “Physical Channels and Modulation”, May 2009

### SUMMARY OF INVENTION

### Technical Problem

Conventionally, the LTE does not take account of correspondence between the control information region and the user data region in assignment of the resource blocks to the mobile station by the base station. According to the LTE, that is, the control information region and the user data region are conventionally assigned to different resource blocks. According to the LTE, in detail, the PDCCH as the control information region is assigned wider in a frequency direction than the PDSCH as the user data region.

Such an assignment of the resource blocks in accordance with the LTE causes a problem when AAS (Adaptive Antenna System) is introduced. The AAS changes directivity of radio waves by performing adaptive control on weighting each of a plurality of antenna elements constituting an array antenna, in accordance with a transmission environment. An adaptive array base station corresponding to the AAS performs the adaptive control such as beamforming, null steering and the like to a desired mobile station by using, in downlink transmission, antenna weights calculated based on reference signals transmitted from the mobile station.

However, the reference signals transmitted from the mobile station relate to the resource block including the user data and, technically speaking, may not be used for the frequency band including the control information disposed outside the resource block. Also, when the control information region is widely assigned in the frequency direction, an advantage of the AAS to increase a gain with respect to a desired mobile station may not be utilized. As such, the LTE conventionally has a problem that the AAS is inapplicable to the control information transmitted from the base station to the mobile station and the adaptive control such as the beamforming and the null steering may not be performed.

Accordingly, it is an object of the present invention, taking in consideration of such a condition, to provide an adaptive array base station and a communication method for the adaptive array base station which may transmit at least a part of the control information by adaptive array control.

### Solution to Problem

In order to solve the above problem, an adaptive array base station according to a first aspect of the present invention is configured to perform a communication by assigning to a mobile station a part of each of a control information region including control information and a user data region separated from the control information region in a time direction and including user data in a communication frame, and includes:

a calculation unit configured to calculate a transmission weight based on a received signal from the mobile station;

an assigning unit configured to assign, in the communication frame, the control information for one mobile station to the control information region in the same frequency band as the user data region to which the user data for the mobile station are assigned; and

a transmission unit configured to transmit the control information and the user data to the mobile station by adaptive array control based on the transmission weight and assignment of the control information and the user data.

A second aspect of the present invention is the adaptive array base station according to the first aspect, wherein

the assigning unit sets a fixed value for a length of the control information region in the communication frame in a time direction and excludes information about the length of the control information region in the time direction from the control information.

Although an apparatus is used for an explanation of solutions according to the present invention set forth above, it should be understood that the present invention may also be substantialized by a method, a program and a storage medium storing a program that substantially correspond to the equipment, hence these are included within a scope of the present invention.

For example, according to a third aspect of the present invention substantializing the present invention as a method, a communication method for an adaptive array base station configured to perform a communication by assigning to a mobile station a part of each of a control information region including control information and a user data region separated from the control information region in a time direction and including user data in a communication frame, includes:

a step for calculating a transmission weight based on a received signal from the mobile station;

a step for assigning, in the communication frame, control information for one mobile station to the control information region in the same frequency band as the user data region to which the user data for the mobile station are assigned; and

a step for transmitting the control information and the user data to the mobile station by adaptive array control based on the transmission weight and assignment of the control information and the user data.

A fourth aspect of the present invention is the communication method for the adaptive array base station according to the third aspect, wherein

at the step for assigning, a fixed value is set for a length of the control information region in the communication frame in a time direction and information about the length of the control information region in the time direction is excluded from the control information.

### Effect of the Invention

According to the adaptive array base station and the communication method for the adaptive array base station according to the present invention, at least a part of the control information may be transmitted by the adaptive array control.

### BRIEF DESCRIPTION OF DRAWINGS

FIG. 1 is a functional block diagram illustrating a base station according to one embodiment of the present invention;

FIG. 2 is a diagram illustrating an example of assignment of resource blocks according to one embodiment of the present invention;

FIG. 3 is a flowchart illustrating operations of the base station illustrated in FIG. 1; and

FIG. 4 is a diagram illustrating an example of a structure of the resource block according to LTE.

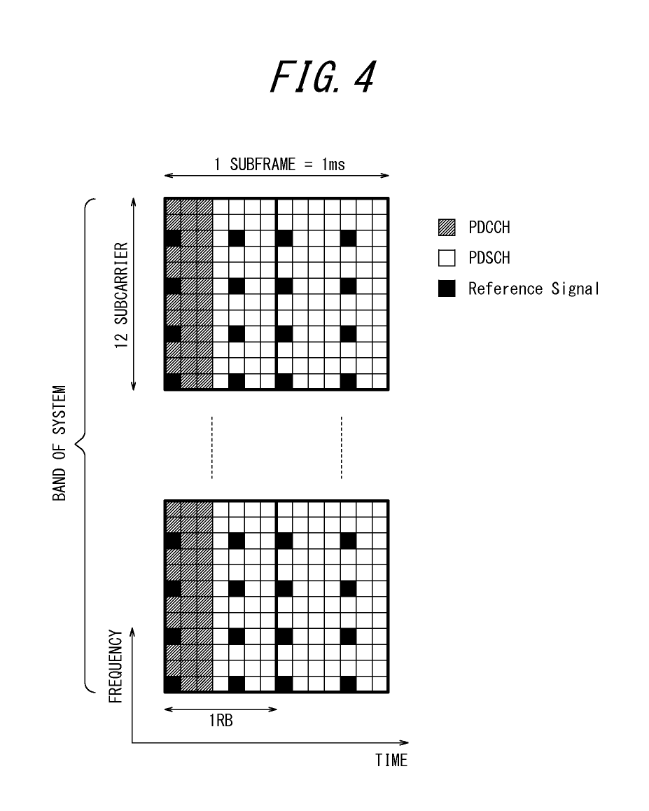

### DESCRIPTION OF EMBODIMENT

An embodiment of the present invention will be described with reference to the accompanying drawings.

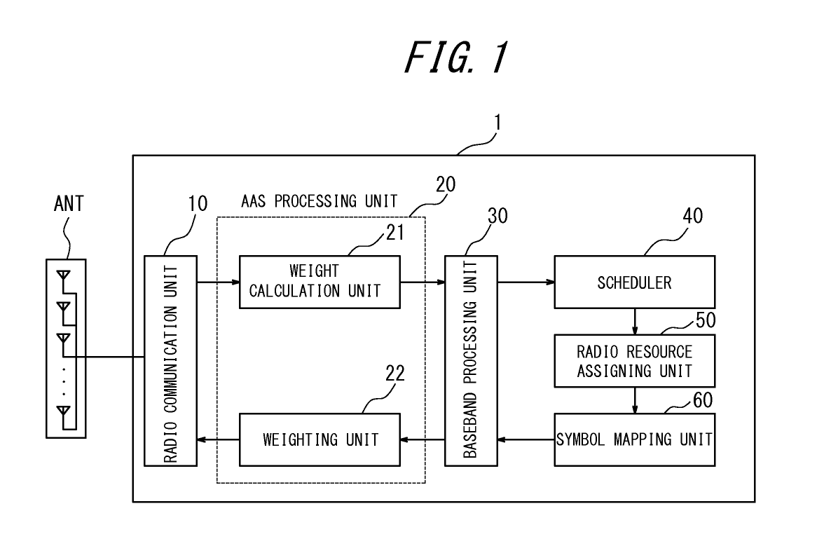

FIG. 1 is a diagram illustrating a schematic configuration of an adaptive array base station 1 according to one embodiment of the present invention. The adaptive array base station 1 includes an array antenna ANT, a radio communication unit (transmission unit) 10, an AAS processing unit 20 including a weight calculation unit (a calculation unit) 21 and a weighting unit 22, a baseband processing unit 30, a scheduler 40, a radio resource assigning unit (an assigning unit) 50 and a symbol mapping unit 60. The radio communication unit 10, the AAS processing unit 20, the baseband processing unit 30 and the symbol mapping unit 60 are constituted by using an interface device/circuit suitable for LTE. The scheduler 40 and the radio resource assigning unit 50 are constituted by using a suitable processor such as a CPU or the like. The following is a detailed description of each of the units.

The radio communication unit 10, as an operation of a reception system, converts a radio signal at a carrier frequency received by the array antenna ANT into a radio signal at a baseband frequency and outputs the generated signal to the weight calculation unit 21. Also, the radio communication unit 10, as an operation of a transmission system, converts a signal at the baseband frequency from the weighting unit 22 into a signal at the carrier frequency and transmits the generated signal to the mobile station via the array antenna ANT by adaptive array control.

The weight calculation unit 21 of the reception system in the AAS processing unit 20 performs adaptive signal processing to a signal input from the radio communication unit 10 and outputs the signal to the baseband processing unit 30. In the adaptive signal processing, in detail, the weight calculation unit 21, by using a reference signal transmitted from the mobile station and other known information, calculates a transmission weight (a weight of a phase/amplitude of each antenna element) which enables high transmission gain with respect to the mobile station, based on phase information obtained for each of the antenna elements of the array antenna ANT and the like. On the other hand, the weighting unit 22 of the transmission system adds the transmission weight obtained by the weight calculation unit 21 to the signal input from the baseband processing unit 30 and outputs the signal to the radio communication unit 10.

The baseband processing unit 30, as the operation of the reception system, demodulates the signal input from the weight calculation unit 21 and outputs a result of demodulation to the scheduler 40 for each mobile station separately. Also, the baseband processing unit 30, as the operation of the transmission system, outputs a symbol array of transmission data for the mobile station input from the symbol mapping unit 60 to the weighting unit 22.

The scheduler 40 sets a mobile station to be assigned a resource block based on received data from each mobile station input from the baseband processing unit 30. In detail, the scheduler 40 sets the mobile station to be assigned the resource block based on channel quality information (CQI), quality of a received signal of each resource block notified by the mobile station, or an amount of data to be transmitted.

The radio resource assigning unit 50 assigns the radio resource to the mobile station set by the scheduler 40. Here, the radio resource assigning unit 50 assigns, in a subframe of the LTE, the control information for a mobile station to the control information region of the resource block to which the user data of the same mobile station are assigned.

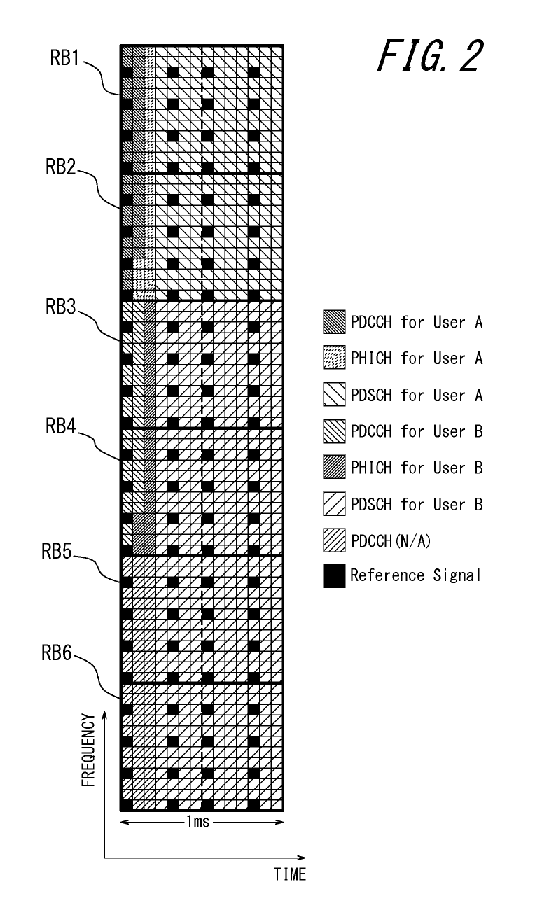

FIG. 2 is a diagram illustrating an example of assignment of the resource blocks by the radio resource assigning unit 50. In FIG. 2, first three symbols in the subframe correspond to the control information region, while fourth symbols and thereafter correspond to the user data region. The radio resource assigning unit 50 assigns resource blocks RB1 and RB2 to a mobile station of a user A and resource blocks RB3 to RB6 to a mobile station of a user B. That is, the radio resource assigning unit 50 assigns the control information (PDCCH and PHICH (Physical Hybrid ARQ Indicator Channel)) for the user A to the control information regions of the resource blocks RB1 and RB2 to which the user data (PDSCH) for the user A are assigned. Also, the radio resource assigning unit 50 assigns the control information (PDCCH and PHICH) for the user B to the control information regions of the resource blocks RB3 to RB6 to which the user data (PDSCH) for the user B are assigned. Thereby, the control information and the user data are included in the same radio communication channel and, therefore, the adaptive array control to the user data may be applied also to the control information.

Upon receiving a result of assignment by the radio resource assigning unit 50, the symbol mapping unit 60 performs symbol mapping (assigns amplitude and a phase) to the transmission data including the control information and the user data for the mobile station in accordance with a modulation method and outputs the generated symbol array to the baseband processing unit 30.

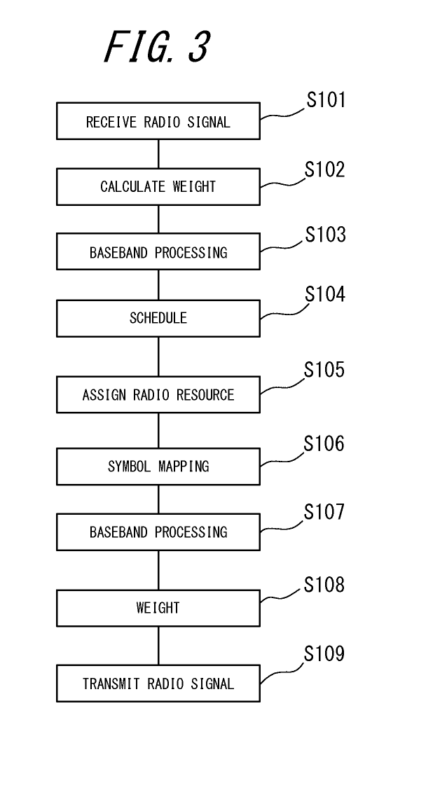

FIG. 3 is a flowchart illustrating operations of the base station 1 illustrated in FIG. 1. Upon reception of the radio signal from the mobile station via the array antenna ANT, the radio communication unit 10 converts the received radio signal at the carrier frequency into the radio signal at the baseband frequency and outputs the generated signal to the weight calculation unit 21 (step S101). The weight calculation unit 21, by using the reference signal transmitted from the mobile station and other known information, calculates a transmission weight that enables to obtain high transmission gain with respect to the mobile station, based on the phase information and the like obtained for each antenna array of the array antenna ANT (step S102). The baseband processing unit 30 demodulates the signal input from the weight calculation unit 21 and outputs the result of demodulation to the scheduler 40 separately for each mobile station (step S103).

The scheduler 40 sets the mobile station to be assigned the resource block based on the received data of each mobile station input from the baseband processing unit 30 (step S104). The radio resource assigning unit 50 assigns the radio resource to the mobile station determined by the scheduler 40 (step S105). Here, the radio resource assigning unit 50 assigns, in the subframe of the LIE, the control information for the mobile station to the control information region of the resource block (radio communication channel) to which the user data of the same mobile station are assigned.

Upon receiving the result of assignment by the radio resource assigning unit 50, the symbol mapping unit 60 performs symbol mapping of the transmission data including the control information and the user data for the mobile station in accordance with the modulation method and outputs the generated symbol array to the baseband processing unit 30 (step S106). The baseband processing unit 30 outputs to the weighting unit 22 the symbol array of the transmission data for the mobile station that is input from the symbol mapping unit 60 (step S107). The weighting unit 22 adds the transmission weight obtained by the weight calculation unit 21 to the signal input from the baseband processing unit 30 and outputs the signal to the radio communication unit 10 (step S108). The radio communication unit 10 converts the signal at the baseband frequency from the weighting unit 22 into the signal at the carrier frequency and transmits the signal to the mobile station via the antenna array ANT by the adaptive array control (step S109).

According to the present embodiment, the radio resource assigning unit 50 assigns, in the subframe of the LIE, the control information for the mobile station to the control information region of the resource block to which the user data of the same mobile station are assigned. Accordingly, the adaptive array base station 1 may transmit at least a part of the control information together with the user data to the mobile station by the adaptive array control. That is, the adaptive array control may be applied to the control information from the base station to the mobile station, thus adaptive control such as beamforming and null steering may be performed.

Although the present invention is described based on figures and the embodiment, it is to be understood that those who are ordinarily skilled in the art may easily vary or alter in a multiple manner based on disclosure of the present invention. Accordingly, such variation and alteration are included in a scope of the present invention. For example, a function or the like of each component or each step can be rearranged avoiding a logical inconsistency, such that a plurality of components or steps are combined or divided.

For example, in the assignment of the resource blocks illustrated in FIG. 2, although the resource blocks RB1 and RB2 are occupied by the mobile station of the user A and the resource blocks RB3 to RB6 are occupied by the mobile station of the user B, each of the resource blocks may be shared by mobile stations of a plurality of users. In this case, the radio resource assigning unit 50, in addition to simply assigning the control information for the mobile station to the control information region of the resource block to which the user data for the same mobile station are assigned, may assign the control information for the mobile station to the control information region of the subcarrier to which the user data for the same mobile station are assigned, corresponding to a finer granularity of the radio communication channel. Accordingly, even when the resource block is shared by a plurality of mobile stations, the control information and the user data may be assigned to a radio communication channel (subcarrier) in a better radio condition. Thereby, efficiency of the adaptive array control may be enhanced.

Also, as illustrated in FIG. 2 in which the resource blocks are assigned to the mobile station of the user B, when the number of resource blocks including the user data (four: RB3 to RB6) is greater than the number of resource blocks including the control information (two: RB3 and RB4), the radio resource assigning unit 50 may assign the control information to the control information region of the resource block in a better radio condition among the resource blocks to which the user data are assigned. Accordingly, the control information and the user data may be assigned to the radio communication channel (or resource block) in a better radio condition. Thereby, efficiency of the adaptive array control may be enhanced.

Moreover, although the control information region of the LIE generally includes PCFICH indicating a length of a symbol in the control information region (the length in the time direction), the radio resource assigning unit 50 may set a fixed value for a length of the symbol in the control information region and exclude the PCFICH from the control information. That is, if the adaptive array base station 1 and the mobile station preliminarily collectively possess a fixed value of the length of the control information region in the time direction, it is not necessary to include information about the fixed value in the control information region. Accordingly, more symbols may be assigned to the user data region.

Further, the number of resource blocks the radio resource assigning unit 50 assigns to one mobile station may be a multiple of two. Generally, the number of reference signals necessary for the adaptive array control changes in accordance with the number of antenna elements of the array antenna ANT. Therefore, when the number of antenna elements is increased, the adaptive array control, in some cases, may not be performed appropriately by using only the reference signals included in one resource block. In such a case, the radio resource assigning unit 50 may ensure an appropriate number of reference symbols by increasing the number of resource blocks to be assigned to one mobile station in multiples of two.

### REFERENCE SIGNS LIST

1 adaptive array base station
10 radio communication unit
20 AAS processing unit
21 weight calculation unit
22 weighting unit
30 baseband processing unit
40 scheduler
50 radio resource assigning unit
60 symbol mapping unit
ANT array antenna

1. An adaptive array base station configured to perform a communication by assigning to a mobile station a part of each of a control information region including control information and a user data region separated from the control information region in a time direction and including user data in a communication frame, the adaptive array base station comprising:
a calculation unit configured to calculate a transmission weight based on a received signal from the mobile station;
an assigning unit configured to assign, in the communication frame, the control information for one mobile station to the control information region in the same frequency band as the user data region to which the user data for the mobile station is assigned; and
a transmission unit configured to transmit the control information and the user data to the mobile station by adaptive array control based on the transmission weight and assignment of the control information and the user data.

2. The adaptive array base station according to claim 1, wherein the assigning unit sets a fixed value for a length of the control information region in the communication frame in a time direction and excludes information about the length of the control information region in the time direction from the control information.

3. A communication method for an adaptive array base station configured to perform a communication by assigning to a mobile station a part of each of a control information region including control information and a user data region separated from the control information region in a time direction and including user data in a communication frame, the communication method comprising:
a step for calculating a transmission weight based on a received signal from the mobile station;
an assigning step for assigning, in the communication frame, control information for one mobile station to the control information region in the same frequency band as the user data region to which the user data for the mobile station is assigned; and
a step for transmitting the control information and the user data to the mobile station by adaptive array control based on the transmission weight and assignment of the control information and the user data.

4. The communication method according to claim 3, wherein, at the assigning step, a fixed value is set for a length of the control information region in the communication frame in a time direction and information about the length of the control information region in the time direction is excluded from the control information.
